(19) United States
(12) Patent Application Publication
(10) Pub. No.: US 2016/0259274 A1
(43) Pub. Date: Sep. 8, 2016

(54) IMAGE FORMING APPARATUS

(71) Applicant: FUJI XEROX Co., Ltd., Tokyo (JP)

(72) Inventors: Yoko MIYAMOTO, Kanagawa (JP); Sho WATANABE, Kanagawa (JP); Tomoaki YOSHIOKA, Kanagawa (JP)

(73) Assignee: FUJI XEROX CO., LTD., Tokyo (JP)

(21) Appl. No.: 14/841,888

(22) Filed: Sep. 1, 2015

(30) Foreign Application Priority Data
Mar. 3, 2015 (JP) 2015-041580

(51) Int. Cl. G03G 15/16

(52) U.S. Cl. CPC G03G 15/1605

(57) ABSTRACT

An image forming apparatus includes an intermediate transfer body rotated in a rotating direction, downstream and upstream image forming sections, and a transfer unit. The downstream image forming section includes image forming units transferring toner images onto the intermediate transfer body and arranged so that lightness of toners reduces toward a downstream side along the rotating direction. The upstream image forming section includes at least one image forming unit using a toner and transferring a toner image onto the intermediate transfer body. The transfer unit transfers the toner images. When a volume mean diameter of the toner of the at least one image forming unit of the upstream image forming section is Dt and a largest volume mean diameter out of volume mean diameters of the toners used in the image forming units of the downstream image forming section is Dmax, Dt>Dmax.

### CROSS-REFERENCE TO RELATED APPLICATIONS

This application is based on and claims priority under 35 USC 119 from Japanese Patent Application No. 2015-041580 filed Mar. 3, 2015.

### BACKGROUND

1. Technical Field

The present invention relates to an image forming apparatus.

2. Summary

According to an aspect of the present invention, an image forming apparatus includes an intermediate transfer body, a downstream image forming section, an upstream image forming section, and a transfer unit. The intermediate transfer body is rotated. The downstream image forming section includes plural image forming units which use toners, which transfer toner images onto the intermediate transfer body, and which are arranged so that lightness of the toners reduces toward a downstream side along a rotating direction of the intermediate transfer body. The upstream image forming section includes at least one image forming unit which uses a toner having a hue different from hues of the toners used in the plural image forming units of the downstream image forming section and having lightness lower than the lightness of one of the toners having highest lightness among the toners used in the downstream image forming section, which transfers a toner image onto the intermediate transfer body, and which is disposed upstream of the downstream image forming section in the rotating direction. The transfer unit transfers the toner images from the intermediate transfer body to a recording medium. When a volume mean diameter of the toner of the at least one image forming unit of the upstream image forming section is Dt and a largest volume mean diameter out of volume mean diameters of the toners used in the plural image forming units of the downstream image forming section is Dmax, Dt >Dmax holds.

### BRIEF DESCRIPTION OF THE DRAWINGS

Exemplary embodiment of the present invention will be described in detail based on the following figures, wherein:

FIG. 1 is a schematic view of the structure of an image forming apparatus according to an exemplary embodiment;

FIG. 2 is a schematic view of toner image forming units according to the exemplary embodiment;

FIG. 3A is a schematic view of a state in which discharge occurs between a toner image on an intermediate transfer belt and a recording medium, and FIG. 3B is a schematic view of a state in which particles of a toner not transferred onto the recording medium remain on the intermediate transfer belt;

FIG. 4 is a graph illustrating a charge distribution of the toner before and after passing through first transfer on a downstream side;

FIG. 5 is a table that summarizes the relationships of the volume mean diameter, the mass per unit area, and the charge amount per unit mass of the toner with color non-uniformity; and

FIG. 6 is a table that summarizes the relationships of the volume resistivity and process speeds of a second transfer belt with the color non-uniformity.

### DETAILED DESCRIPTION

An example of an image forming apparatus according to an exemplary embodiment of the present invention will be described.

### A Configuration of an Image Forming Apparatus 10

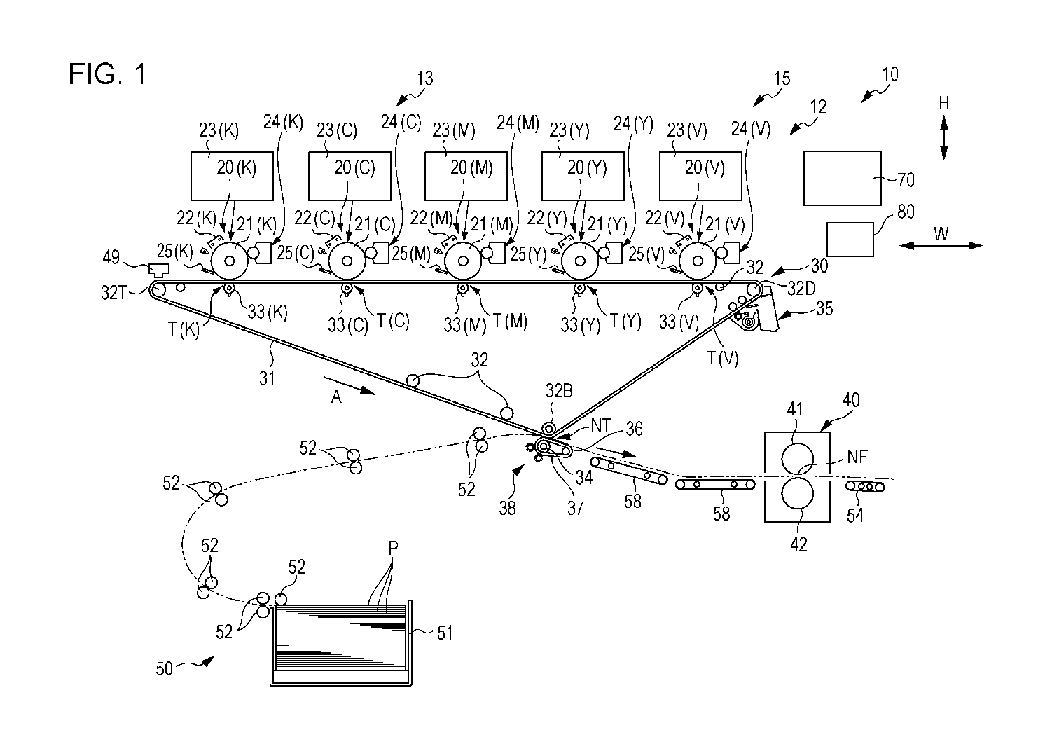

FIG. 1 is a schematic view of a configuration of an image forming apparatus 10 seen in a rotational axis direction of an intermediate transfer belt 31 and photosensitive drums 21, which will be described later. As illustrated in FIG. 1, the image forming apparatus 10 includes an image forming section 12, a transport device 50, a controller 70, and a power source unit 80. The image forming section 12 forms images on sheet-shaped recording media P such as sheets of paper with an electrophotographic method. The transport device 50 transports the recording media P. The controller 70 controls operations of components of the image forming apparatus 10. The power source unit 80 supplies power to the components of the image forming apparatus 10.

### The Transport Device

As illustrated in FIG. 1, the transport device 50 includes a container unit 51 and plural transport rollers 52. The container unit 51 contains the recording media P. The transport rollers 52 transport each of the recording media P from the container unit 51 to a second transfer position NT, which will be described later. The transport device 50 further includes plural transport belts 58 and a transport belt 54. The transport belts 58 transport the recording medium P from the second transfer position NT to a fixing device 40. The transport belt 54 transports the recording medium P from the fixing device 40 toward a recording-medium P output unit (not illustrated).

### The Image Forming Section

The image forming section 12 includes the intermediate transfer belt 31, toner image forming units 20, a second transfer device 38, and the fixing device 40. The toner image forming units 20 form toner images and transfer the toner images onto the intermediate transfer belt 31 through first transfer. The second transfer device 38 transfers the toner images having been transferred onto the intermediate transfer belt 31 onto the recording medium P through second transfer. The fixing device 40 heats and applies pressure to the toner images having been transferred onto the recording medium P so as to fix the toner images onto the recording medium P.

### The Toner Image Forming Units 20

The plural toner image forming units 20 are provided so that the toner images of respective colors are formed and transferred onto the intermediate transfer belt 31. According to the present exemplary embodiment, a total of five toner image forming units 20, that is, the toner image forming units 20 for a special color (V), yellow (Y), magenta (M), cyan (C), and black (K) are provided. Signs (V), (Y), (M), (C), and (K) indicate components corresponding to the above-described respective colors. These signs may be described only by characters V, Y, M, C, and K with the parentheses of (V), (Y), (M), (C), and (K) omitted in the description herein. Furthermore, in the description where the colors are not distinguished, V, Y, M, C, and K are appropriately omitted.

The toner image forming units 20 for these colors, that is, the special color (V), yellow (Y), magenta (M), cyan (C), and black (K) are arranged in this order from an upstream side toward a downstream side in a transport direction of the intermediate transfer belt 31, which will be described later.

The lightness (L*) of toners used in the yellow (Y), magenta (M), cyan (C), and black (K) toner image forming units 20Y, M, C, and K reduce toward the downstream side. The toners of the colors will be described later.

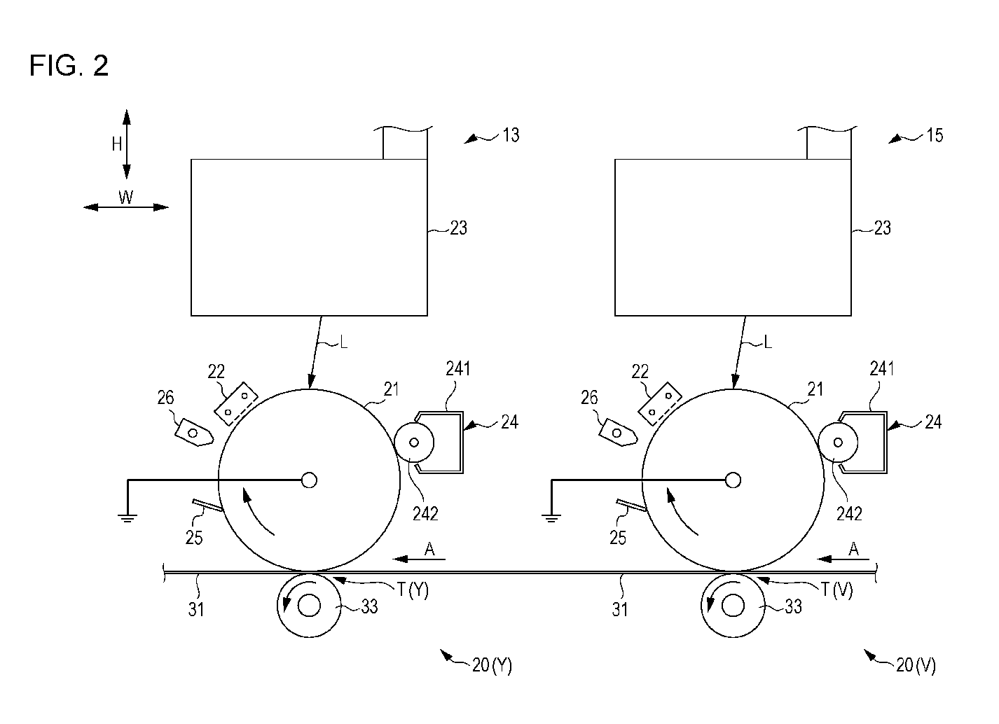

The toner image forming units 20 for the respective colors other than the toners used therein have structures that are substantially the same. Specifically, as illustrated in FIG. 2, the toner image forming units 20 for the colors each include a photosensitive drum 21, a charger 22, and a first transfer roller 33. The photosensitive drum 21 is rotated clockwise in FIG. 2. The charger 22 charges the photosensitive drum 21.

Each of the toner image forming units 20 for a corresponding one of the colors further includes a light exposure device 23, a developing device 24, a photosensitive body cleaner 25, and a static eliminator 26. The light exposure device 23 causes the photosensitive drum 21 having been charged by the charger 22 to be exposed to light so as to form an electrostatic latent image on the photosensitive drum 21. The developing device 24 develops the electrostatic latent image having been formed on the photosensitive drum 21 by the light exposure device 23 so as to form a toner image.

### The Developing Devices

As illustrated in FIG. 2, each of the developing devices 24 includes a container 241 and a developing roller 242. The container 241 contains developer G. Due to a potential difference generated between the developing roller 242 and the photosensitive drum 21 by applying a developing bias voltage to the developing roller 242, the electrostatic latent image formed on an outer circumferential surface of the photosensitive drum 21 becomes visible as a toner image.

### The Photosensitive Body Cleaners

Each of the photosensitive body cleaners 25 includes a blade 251. Toner remaining on the surface of a corresponding one of the photosensitive drums 21 after the toner image has been transferred to the transfer device 30 through the first transfer is scraped off from the surface of the photosensitive drum 21 by the blade 251.

### The First Transfer Rollers

The first transfer rollers 33 each transfer the toner image from a corresponding one of the photosensitive drums 21 to the intermediate transfer belt 31 and are disposed inside the intermediate transfer belt 31. The first transfer rollers 33 each face the photosensitive drum 21 for a corresponding one of the colors with the intermediate transfer belt 31 interposed therebetween. By applying a first transfer voltage, the polarity of which is opposite to the polarity to which the toner is charged, to each of the first transfer rollers 33, the toner image formed on the photosensitive drum 21 is transferred onto the intermediate transfer belt 31 at a corresponding one of first transfer positions T.

### The Intermediate Transfer Belt

The intermediate transfer belt 31 is an endless belt looped over plural rollers 32 as illustrated in FIG. 1. Out of the plural rollers 32, a roller 32D functions as a drive roller that rotates the intermediate transfer belt 31 in an arrow A direction with power from a motor (not illustrated).

By rotating the intermediate transfer belt 31 in the arrow A direction, the toner images of the colors on the respective photosensitive drums 21 transferred at the respective first transfer positions T through the first transfer are superposed on one another, and the superposed toner image is transported to the second transfer position NT. The toner image having been transported to the second transfer position NT is transferred onto the recording medium P through the second transfer by the second transfer device 38.

Out of the plural rollers 32, a roller 32T functions as a tension applying roller that applies tension to the intermediate transfer belt 31. Out of the plural rollers 32, a roller 32B functions as a facing roller 32B that faces the second transfer roller 34, which will be described later.

A belt cleaner 35, which cleans the intermediate transfer belt 31, is disposed at a position that is downstream of the second transfer position NT and upstream of the first transfer position T (V) in a direction (arrow A direction) in which the intermediate transfer belt 31 is rotated.

### The Second Transfer Device

The second transfer device 38 transfers the superposed toner image on the intermediate transfer belt 31 onto the recording medium P. The second transfer device 38 includes a second transfer belt 37. The second transfer belt 37 is an endless belt looped over the second transfer roller 34 and a driven roller 36.

The second transfer roller 34 is disposed such that the intermediate transfer belt 31 and the second transfer belt 37 are interposed between the second transfer roller 34 and the aforementioned facing roller 32B. The second transfer belt 37 and the intermediate transfer belt 31 are in contact with each other at a predetermined load. A nip between the second transfer belt 37 and the intermediate transfer belt 31 that are in contact with each other in such a manner is the second transfer position NT.

The recording medium P is supplied from the container unit 51 to the second transfer position NT at appropriate timing. The second transfer belt 37 is rotated by rotation of the second transfer roller 34.

According to the present exemplary embodiment, in order to transfer the toner image from the intermediate transfer belt 31 to the recording medium P, a negative voltage is applied to the facing roller 32B by the power source unit 80. This generates a potential difference between the facing roller 32B and the second transfer roller 34. That is, by applying the negative voltage to the facing roller 32B, a second transfer voltage (positive voltage), the polarity of which is opposite to the polarity to which the toners are charged, is indirectly applied to the second transfer roller 34 that serves as a counter electrode of the facing roller 32B. This causes the toner image to be transferred from the intermediate transfer belt 31 to the recording medium P passing through the second transfer position NT.

### The Fixing Device

The fixing device 40 fixes the toner image onto the recording medium P onto which the toner image has been transferred. Specifically, the fixing device 40 includes a heating roller 41 and a pressure roller 42. The toner image is heated while being pressed in a fixing nip NF formed between the heating roller 41 and the pressure roller 42 so as to be fixed onto the recording medium P.

### Image Forming Operation

Next, an outline of image forming steps performed on the recording medium P by the image forming apparatus 10 is described.

In response to an image forming instruction, the controller 70 causes the toner image forming units 20, the second transfer device 38, and the fixing device 40 to operate in the image forming apparatus 10 illustrated in FIG. 1. The controller 70 also causes the transport device 50 and so forth to operate in synchronization with the operations of the toner image forming units 20, the second transfer device 38, and the fixing device 40.

The photosensitive drums 21 for the colors are charged by the respective chargers 22 while being rotated. Furthermore, the controller 70 causes image data having undergone image processing performed by an image signal processing unit to be transmitted to the light exposure devices 23. Each of the light exposure devices 23 radiates exposure light L (see FIG. 2) in accordance with the image data so as to cause a corresponding one of the charged photosensitive drums 21 to be exposed to the exposure light L. Thus, an electrostatic latent image is formed on the outer circumferential surface of each of the photosensitive drums 21. The electrostatic latent images formed on the photosensitive drums 21 are developed by the respective developing devices 24. Thus, the toner images of the special color (V), yellow (Y), magenta (M), cyan (C), and black (K) are formed on the photosensitive drums 21 for the respective colors.

The toner images of the colors formed on the photosensitive drums 21 for the respective colors are sequentially transferred onto the rotating intermediate transfer belt 31 by the first transfer rollers 33 for the respective colors at the respective first transfer positions T through the first transfer. Thus, superposed toner image made by superposing the toner images are formed on the intermediate transfer belt 31. This superposed toner image is transported to the second transfer position NT by rotation of the intermediate transfer belt 31. The recording medium P is fed to this second transfer position NT by the transport rollers 52 at timing adjusted to transportation of the superposed toner image. The superposed toner image is transferred from the intermediate transfer belt 31 onto the recording medium P at this second transfer position NT through the second transfer.

The recording medium P onto which the toner image has been transferred through the second transfer is transported toward the fixing device 40 by the transport belts 58 while being sucked to the transport belts 58 by a negative pressure. The fixing device 40 applies heat and pressure to the recording medium P passing through the fixing nip NF. Thus, the toner image having been transferred onto the recording medium P is fixed onto the recording medium P.

The recording medium P onto which the toner image has been fixed by the fixing device 40 is transported by the transport belt 54 and output to the output unit (not illustrated).

Residual toners, which have not been transferred through the second transfer and remain on the intermediate transfer belt 31, are removed by the belt cleaner 35.

### Configurations of the Elements

Next, configurations of elements according to the present exemplary embodiment are described.

### The Toners

Here, the image forming section 12 includes a downstream image forming section 13 and an upstream image forming section 15. The downstream image forming section 13 includes the yellow (Y), magenta (M), cyan (C), and black (K) toner image forming units 20Y, M, C, and K and the upstream image forming section 15 includes the special color (V) toner image forming unit 20V. As has been described, the lightness (L*) of the toners used in the downstream image forming section 13 reduces toward the downstream side.

In the image forming section 12, hue of the toner (V) of the special color used in the toner image forming unit 20 (V) of the upstream image forming section 15 is different from those of the toners Y, M, C, and K used in the toner image forming units 20 Y, M, C, and K of the downstream image forming section 13. Furthermore, the toner (V) of the special color has a lower lightness (L*) than that of the yellow toner Y used in the yellow toner image forming unit 20 (Y), which has the highest lightness (L*) among the toners Y, M, C, and K.

According to the present exemplary embodiment, the special color (V) is green.

Furthermore, when the volume mean diameter of the toner V of the special color (V) used in the upstream image forming section 15 is Dt and a largest volume mean diameter out of those of the toner Y of yellow (Y), the toner M of magenta (M), the toner C of cyan (C), and the toner K of black (K) used in the downstream image forming section 13 is Dmax, the following relationship holds:

Dt>Dmax.

Here, according to the present exemplary embodiment, the volume mean diameters of the toner Y of yellow (Y), the toner M of magenta (M), the toner C of cyan (C), and the toner K of black (K) are the same.

Furthermore, toner specifications of the toner V of the special color (V) and those of the toner Y of yellow (Y), the toner M of magenta (M), the toner C of cyan (C), and the toner K of black (K) are the same except for the volume mean diameters and the colors.

The volume mean diameter is measured with a particle distribution measuring instrument (Coulter Multisizer II, made by Beckman Coulter, Inc.) and ISOTON-II (made by Beckman Coulter, Inc.) is used as an electrolytic solution.

The measurement is performed by the following method: that is, 0.5 to 50 mg of a measurement sample is added to a surfactant as a dispersant, preferably 2 ml of a 5% aqueous solution of sodium alkylbenzene sulfonate, and the resulting solution is added to 100 to 150 ml of the above-described electrolyte solution. The electrolyte solution in which the measurement sample is suspended is subjected to a dispersing process for one minute with an ultra-sonic dispersion system, and the particle size distribution is measured by the Coulter Multisizer II using an aperture of a 100 μm aperture diameter. The number of measured particles is 50000.

A cumulative distribution for divided particle size ranges (channels) is plotted from the small diameter side in accordance with the measured particle size distribution, and a particle diameter corresponding to 50% of a cumulative volume is defined as the volume mean diameter.

### The Toner Images

It is assumed that the mass per unit area (g/m²) and the charge amount per unit mass (μC/g) of a toner image transferred through the first transfer onto the intermediate transfer belt 31 by any one of the toner image forming units 20 are respectively TMA and TV.

When TMA and TV of a toner image VV transferred through the first transfer onto the intermediate transfer belt 31 by the toner image forming unit 20 (V) used in the upstream image forming section 15 are respectively TMAt and TVt, and largest TMA and TV of TMAs and TVs of toner images YY, MM, CC, and KK transferred through the first transfer onto the intermediate transfer belt 31 by the toner image forming units 20 (Y), (M), (C), and (K) used in the downstream image forming section 13 are respectively TMAmax and TVmax, the relationship TMAt×TVt≦TMAmax×TVmax holds.

The above-described TMAt, TVt, TMAmax, and TVmax are compared for the toner images having the same area coverage. According to the present exemplary embodiment, the comparison is made for the toner images the area coverages of which are 100%.

When the toner image of TMAmax is different from the toner image of TVmax, (for example, when TMA of the toner image YY is TMAmax and TV of the toner image MM is TVmax), the toner image of largest TMA×TV, that is, the largest charge amount per unit area (μC/m²), is selected.

A method of measuring TMA is as follows: an image the area coverage of which is 100% and the area of which is known is formed on the recording medium P and taken out before the image is fixed; the weight of the toner used therein is measured; and TMA is calculated. A method of measuring TV is as follows: developer G containing a certain amount of carrier (for example, 0.1 to 0.2 g) is taken out from the developing device 24; the developer G is put in a metal cage partially formed of a mesh, air or the like is blown to the metal cage so that only the toner flies up and leaves through the mesh, and the charge amount per unit weight is calculated from a change in the charge amount and a change in weight before and after the flying and leaving of the toner.

Here, the method of measuring TV described above is described in more detail.

The cylindrical metal cage is prepared. The metal cage is provided with 10 μm metal mesh portions disposed at both ends thereof.

Initially, the developer G containing the carrier is put into the metal cage, and the weight of the developer G together with the metal cage is measured.

Next, air is blown to the metal cage to which a Coulomb meter (charge amount measuring device) is connected.

Only the toner flies and leaves through the metal mesh and the carrier remains in the metal cage.

The Coulomb meter reads the charge amount reduced by the charge amount of the toner having flown and left.

At last, the weight of the carrier together with the metal cage is measured. This allows the weight of the carrier itself to be recognized.

TV is calculated as follows: TV=(reduction in the charge amount)÷((weight before flying and leaving)−(weight after flying and leaving)).

In order to establish “TMAt×TVt≦TMAmax×TVmax”, any method may be used. For example, layer thicknesses of the toner images formed on the photosensitive drums 21 for the colors may be adjusted. The layer thicknesses of the toner images are adjustable by, for example, changing the developing biases applied to the developing rollers 242. Alternatively, TV may be adjusted. For example, a certain degree of the adjustment is possible by increasing the amount of the toner supplied to the developing device 24 so as to increase TC (rate of the toner in the entire developer G) in the developing device 24, thereby reducing TV.

### The Second Transfer Belt

The second transfer belt 37 is formed as follows: that is, resin such as polyimide resin in which a conductive material such as carbon black is dispersed or a rubber material such as chloroprene rubber in which a conductive material such as carbon black is dispersed are coated with polytetrafluoroethylene or the like in which a conductive material is dispersed as is the case with the resin or the rubber material. The volume resistivity of the second transfer belt 37 is set to 10¹² Ωcm or more. According to the present exemplary embodiment, the volume resistivity of the second transfer belt 37 is set to 10¹³ Ωcm.

### Operations

Next, operations according to the present exemplary embodiment are described.

### A COMPARATIVE EXAMPLE

The volume mean diameters of the toners having been described above in “Configuration of the Elements” of the present exemplary embodiment are in the following relationship: “Dt>Dmax”. Here, a case of an image forming apparatus of a comparative example is initially described in which the volume mean diameters are not in the relationship “Dt>Dmax”, that is, the case in which the volume mean diameters are in the relationship “Dt≦Dmax”.

Color non-uniformity is not visually recognizable in the toner image of multiple toner colors formed by superposing on one another at least two of the following toner images of the colors not including the special color (V): the toner image YY of yellow (Y), the toner image MM of magenta (M), the toner image CC of cyan (C), and the toner image K of black (K) used in the downstream image forming section 13.

However, the color non-uniformity may be visually recognizable in a toner image of multiple toner colors including the special color (V) formed by superposing at least one of the toner images YY, MM, and CC of yellow (Y), magenta (M), and cyan (C) used in the downstream image forming section 13 on the toner image VV of the special color (V) used in the upstream image forming section 15. As the area coverage of the toner image of the multiple toner colors including the special color (V) increases, the likelihood of the color non-uniformity being visually recognizable tends to largely increase. Specifically, when the area coverage of the toner image of the multiple toner colors including the special color (V) is 70% or more, the likelihood of the color non-uniformity being visually recognizable tends to largely increase. It is noted that, when the toner image of the multiple toner colors including the special color (V) includes black (K), which is dark compared to the other colors, the color non-uniformity is not noticeable or not visually recognizable even in the case where the color non-uniformity occurs in the special color (V).

Causes of the color non-uniformity occurring in the toner image of the multiple toner colors including the special color (V) have been investigated. As a result, it has been found that one of the causes of the color non-uniformity is transfer failure due to discharge occurring in the second transfer.

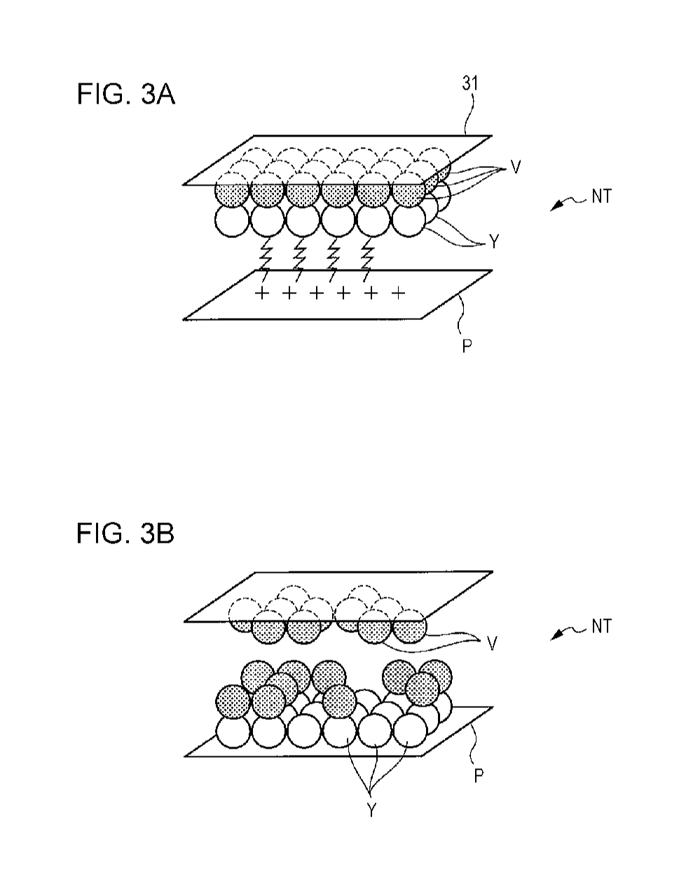

Specifically, as illustrated in FIG. 3A, the discharge occurs between the toner image of the multiple toner colors (a toner image of two toner colors formed by superposing the toner image YY of yellow (Y) on the toner image VV of the special color (V) in an example illustrated in FIGS. 3A and 3B) and the recording medium P charged to the positive polarity (opposite to the polarity of the toners). This reverses the polarity of some particles of the toners (to positive polarity). Consequently, as illustrated in FIG. 3B, the transfer failure occurs in which some of the polarity-reversed (to the positive polarity) particles of the toner V on the intermediate transfer belt 31 side remain on the intermediate transfer belt 31.

Here, it is thought that, also in the case of the toner image of the multiple toner colors not including the special color (V), the discharge occurs, the polarity of some toner particles are reversed (to the positive polarity), and some of the toner particles on the intermediate transfer belt 31 side remain on the intermediate transfer belt 31. However, the color non-uniformity is not visually recognizable in the toner image of multiple toner colors not including the special color (V) as described above.

The difference in visual recognizability of the color non-uniformity between the toner image of the multiple toner colors including the special color (V) as described above and the toner image of the multiple toner colors not including the special color (V) is caused by the difference in lightness (L*) of the toners of the colors. That is, the likelihood of the color non-uniformity caused by the transfer failure illustrated in FIGS. 3A and 3B being noticeable increases when the lightness of the toner on the intermediate transfer belt 31 side is lower than that on the recording medium P side and the difference in lightness increases.

Furthermore, as has been described, as the area coverage of the toner image of the multiple toner colors including the special color (V) increases, the likelihood of the color non-uniformity being visually recognizable tends to noticeably increase. The reason for this is as follows: that is, when the area coverage of a toner image reduces, a portion where no toner exists is generated due to a screen structure, and accordingly, even when some of the toner particles on the intermediate transfer belt 31 side remain on the intermediate transfer belt 31, it is unlikely to be noticeable.

It has also been found that, as the number of times of empty transfer in which a toner image transferred onto the intermediate transfer belt 31 through the first transfer passes through the first transfer on the downstream side increases, the number of times of the occurrences of the transfer failure due to the discharge tends to increase. In other words, it has been found that the transfer failure due to the discharge is more likely to occur in a toner image formed by the toner image forming unit 20 disposed at a further upstream position. That is, it has been found that the transfer failure due to the discharge is most likely to occur in the toner image VV formed by the most upstream toner image forming unit 20V for the special color (V).

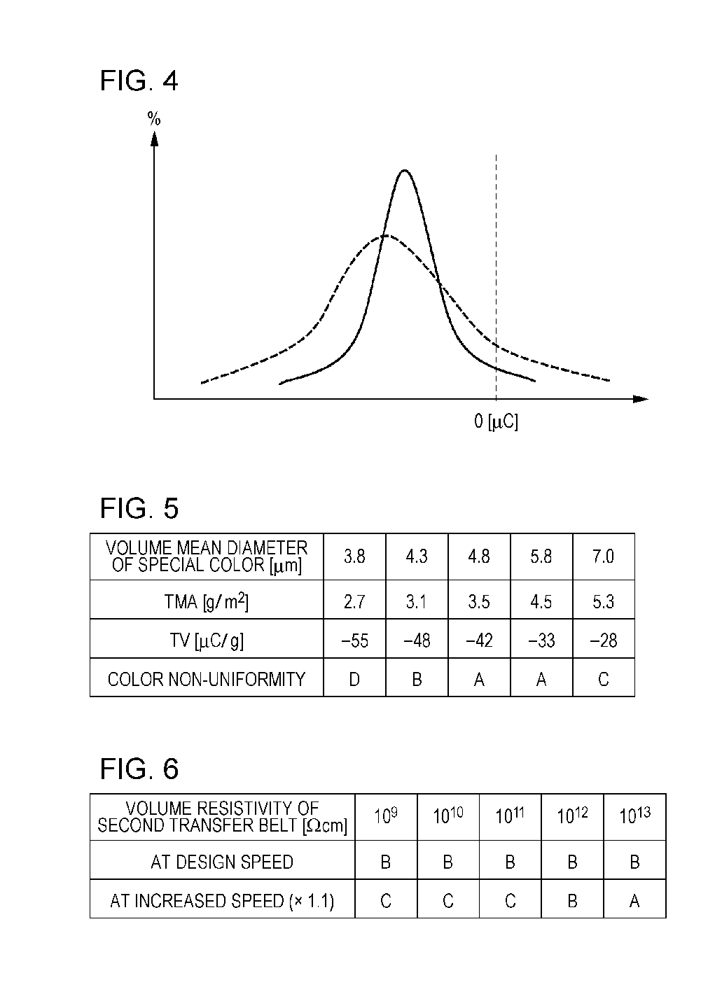

The cause of this phenomenon is reduction of the charge amount of some of the toner particles due to an increase in a charge distribution of the toner as illustrated in FIG. 4 caused by the discharge and charge injection to the toner occurring when the toner image transferred onto the intermediate transfer belt 31 through the first transfer passes through the first transfer on the downstream side. As illustrated in FIGS. 3A and 3B, the polarity of the toner having the reduced charge amount is likely to be reversed (to the positive polarity) in a second transfer unit, and consequently, the toner is likely to remain on the intermediate transfer belt 31.

Referring to FIG. 4, a solid line represents a charge distribution of the toner image transferred onto the intermediate transfer belt 31 through the first transfer, and a dashed line represents a charge distribution of the toner image transferred through the first transfer and passed through the first transfer on the downstream side.

### The Toner Images

Next, the toner image of the multiple toner colors including the special color (V) according to the present exemplary embodiment is described.

According to the present exemplary embodiment, when the volume mean diameter of the toner V of the special color (V) used in the upstream image forming section 15 is Dt and a largest volume mean diameter out of those of the toner Y of yellow (Y), the toner M of magenta (M), the toner C of cyan (C), and the toner K of black (K) used in the downstream image forming section 13 is Dmax, the following relationship holds:

Dt>Dmax.

When the particle diameter of the toner V of the special color (V) is increased as described above, the surface area of the toner V increases. As a result, a charge amount per particle Q of the toner V increases. That is, the charge amount per particle Q of the toner V of the special color (V) becomes larger than those of the toner Y, the toner M, the toner C, and the toner K. When the charge amount Q of the toner V increases as described above, the likelihood of the polarity of the toner V being reversed reduces even when the discharge occurs between the toner image and the recording medium P as illustrated in FIG. 3A. When the amount of the toner V the polarity of which is not reversed increases, the amount of the toner V remaining on the intermediate transfer belt 31 reduces. This may reduce the likelihood of the color non-uniformity being visually recognized. Furthermore, by increasing the particle diameter of the toner V of the special color (V), a toner image including the toner particles having a small particle diameter is superposed on a toner image including the toner particles having a large particle diameter. This may reduce transfer non-uniformity and accordingly, may reduce the color non-uniformity.

Furthermore, a discharge amount of the discharge between the toner image and the recording medium P illustrated in FIG. 3A is proportional to the charge amount of the entire toner image. Thus, when the charge amount per unit area of the toner image (=TMA×TV) increases, the discharge amount increases. This increases the amount of the toners charged to the reversed polarity.

Thus, when TMA and TV of the toner image VV transferred through the first transfer onto the intermediate transfer belt 31 by the toner image forming unit 20 (V) used in the upstream image forming section 15 are respectively TMAt and TVt, and largest TMA and TV, TV being the charge amount per unit mass (μC/g), of TMAs and TVs of the toner images YY, MM, CC, and KK transferred through the first transfer onto the intermediate transfer belt 31 by the toner image forming units 20 (Y), (M), (C), and (K) used in the downstream image forming section 13 are respectively TMAmax and TVmax, the relationship TMAt×TVt≦TMAmax×TVmax holds.

Accordingly, the discharge amount of the toner image of the multiple toner colors including the special color toner (V) can be equal to or less than the maximum discharge amount of the toner image of the multiple toner colors not including the special color toner (V). This may suppress the transfer failure, and accordingly, suppress the color non-uniformity. In the above-described relationship, the number of colors (the number of color toners) of the toner image of the multiple toner colors including the special color toner (V) and the number of colors of the toner image of the multiple toner colors not including the special color toner (V) are the same. For example, when the toner image including the special color toner (V) is a toner image of two toner colors, the toner image not including the special color toner (V) is also a toner image of two toner colors.

Furthermore, by setting the volume resistivity of the second transfer belt 37 to a high value of 10¹² Ωcm or more, the discharge amount is reduced. This may suppress the transfer failure, and accordingly, suppress the color non-uniformity.

In other words, when the volume resistivity of the second transfer belt 37 is less than 10¹² Ωcm, a transfer current of the second transfer flows from end portions of the recording medium P in the width direction to the second transfer belt 37. This reduces electric fields at the ends of the recording medium P. When the transfer voltage (or transfer current) is increased so as to reliably maintain the electric fields at the end portions of the recording medium P, the electric field in a central portion of the recording medium P in the width direction is increased. This increases the discharge amount between the toner image and the recording medium P. As a result, the color non-uniformity in the central portion of the recording medium P in the width direction may be likely to be visually recognizable.

However, by setting the volume resistivity of the second transfer belt 37 to a high value of 10¹² Ωcm or more as described above, a transfer current of the second transfer that flows from the end portions of the recording medium P in the width direction to the second transfer belt 37 is suppressed. In this case, since it is not required to increase the transfer voltage (transfer current) to reliably maintain the electric fields at the end portions of the recording medium P, the discharge amount is suppressed. As a result, the transfer failure may be suppressed, and accordingly, the color non-uniformity may be suppressed. The width direction of the recording medium P is the same as the rotational axis direction of the intermediate transfer belt 31.

### A Verification Experiment

Next, a verification experiment is described. This verification experiment is performed to verify that the color non-uniformity is suppressed with the image forming apparatus 10 according to the present exemplary embodiment.

In this experiment, a green toner is used as the special color (V) used in the upstream image forming section 15, and the toner image of the two toner colors is formed by superposing the yellow toner image YY of yellow (Y) on the green toner image VV. The color non-uniformity in the resulting toner images is visually evaluated.

Furthermore, the volume mean diameters of the toner Y of yellow (Y), the toner M of magenta (M), the toner C of cyan (C), and the toner K of black (K) used in the downstream image forming section 13 are uniformly set to 3.8 μm. The images are formed with the volume mean diameter of the green toner of the special color (V) used in the upstream image forming section 15 set to the following values: 3.8 μm, 4.3 μm, 4.8 μm, 5.8 μm, and 7.0 μm.

Furthermore, TMA and TV of the special color (V) are measured for each of the particle diameters. TMA and TV of the toner image VV of the special color (V) having a particle diameter of 3.8 μm are the same as those of the toner Y of the yellow (Y) having a particle diameter of 3.8 μm. TMA and TV of the toner Y of yellow (Y) are respectively TMAmax and TVmax.

A table of FIG. 5 summarizes the results. Grades indicated by D, C, B, and A are given to the results of visual evaluation of the color non-uniformity. The color non-uniformity is reduced in the following order: that is, from D, C, B, to A.

According to the table in FIG. 5, the color non-uniformity is noticeable (given the grade of D) when the volume mean diameter of the toner V of the special color (V) is 3.8 μm that is the same as the volume mean diameter of the toner Y of yellow (Y). However, the color non-uniformity is suppressed when the volume mean diameter of the toner V of the special color (V) is 4.3 μm or more that is larger than the volume mean diameter of the yellow toner Y of yellow (Y).

Furthermore, when the volume mean diameter of the toner V of the special color (V) is 4.8 μm or more, the relationship “TMAt×TVt≦TMAmax×TVmax” holds, and the color non-uniformity is further suppressed (given the grade of A).

The color non-uniformity becomes slightly noticeable again when the volume mean diameter of the toner V of the special color (V) is increased to 7.0 μm (given the grade of C). It is thought that this is not caused by the transfer failure in the second transfer but caused by an increase in the amount of retransfer toner in the first transfer. The retransfer toner refers to the toner of the toner image having been transferred through the first transfer and attracted to the photosensitive drum 21 on the downstream side through the first transfer on the downstream side.

This color non-uniformity occurs in accordance with a profile of nip pressure in the first transfer in the axial direction. The occurrence of the color non-uniformity is increased toward end portions in the axial direction. That is, it is thought that in-plane color non-uniformity is caused by the retransfer non-uniformity.

Next, the color non-uniformity in the toner images of the two toner colors is visually evaluated with the volume resistivity of the second transfer belt 37 used to form these toner images varied as follows: 10⁹ Ωcm, 10¹⁰ Ωcm, 10¹¹ Ωcm, 10¹² Ωcm, and 10¹³ Ωcm. The evaluation is performed at two process speeds (rotational speed of the intermediate transfer belt 31), that is, a design process speed and a process speed 1.1 times higher than the design process speed. For the visual evaluation of the color non-uniformity in the toner image, toner image of the two toner colors is formed by superposing the toner image YY of yellow (Y) having a volume mean diameter of 3.8 μm on the toner image VV of green (Green) as the special color (V) having a volume mean diameter of 4.3 μm. When the process speed is multiplied by 1.1, the second voltage is also required to be multiplied by about 1.1. Thus, the voltage is multiplied by 1.1.

A table of FIG. 6 summarizes the results. When the volume resistivity is less than 10¹² Ωcm (10¹¹ Ωcm or less) and the process speed (rotational speed of the intermediate transfer belt 31) is 1.1 times higher than the design speed, the color non-uniformity occurs (given the grade of C). However, with a volume resistivity of 10¹² Ωcm, the color non-uniformity is suppressed (given the grade of B), and with a volume resistivity of 10¹³ Ωcm, the color non-uniformity is further suppressed (given the grade of A). That is, by setting the volume resistivity of the second transfer belt 37 to 10¹² Ωcm or more, the color non-uniformity may be suppressed.

### Variations

The exemplary embodiment of the present invention is not limited to the above-described exemplary embodiment.

For example, according to the above-described exemplary embodiment, when the volume mean diameter of the toner V of the special color (V) used in the upstream image forming section 15 is Dt and the largest volume mean diameter out of those of the toner Y of yellow (Y), the toner M of magenta (M), the toner C of cyan (C), and the toner K of black (K) used in the downstream image forming section 13 is Dmax, the following relationship holds: Dt>Dmax. However, this is not limiting.

Alternatively, the relationship Qt>Qmax may hold where Qt is the charge amount per particle of the toner V of the special color (V) used in the upstream image forming section 15 and Qmax is a largest charge amount per toner particle out of those of the toner Y of yellow (Y), the toner M of magenta (M), the toner C of cyan (C), and the toner K of black (K) used in the downstream image forming section 13.

This setting reduces the likelihood of the polarity of the toner V being reversed even when the discharge occurs between the toner image and the recording medium P. An increase in the amount of the toner V the polarity of which is not reversed reduces the amount of the toner V remaining on the intermediate transfer belt 31. This may reduce the likelihood of the color non-uniformity being visually recognized (see FIGS. 3A and 3B).

The charge amount Q per toner particle may be adjusted by changing the toner specifications. For example, the charge amount Q per toner particle may be adjusted by changing the type of a charge control agent (CCA) as an internal additive or the amount by which the CCA is added. Alternatively, in the case of a two-component developing method, the charge amount Q per toner particle may be adjusted by changing the type or the like of carrier particles. The charge amount Q per toner particle may be measured by utilizing E-spart Analyzer made by Hosokawa Micron Corporation.

According to the present exemplary embodiment, the special color (V) used in the upstream image forming section 15 is green. However, the special color (V) is not limited to this. For example, the special color (V) may be orange or violet. In short, it is sufficient that the hue of the special color (V) be different from those of the toners used in the image forming units of the downstream image forming section and the lightness of the toner of the special color (V) be lower than the lightness of the toner used in uppermost one of the image forming units of the downstream image forming section.

According to the above-described exemplary embodiment, the upstream image forming section includes a single image forming unit. However, the upstream image forming section may include two or more image forming units. When the upstream image forming section 15 includes plural image forming units, the volume mean diameter Dt of the toner used in each of the image forming units of the upstream image forming section is made to be larger than Dmax on the downstream side, or the charge amount per toner particle Qt of the toner used in each of the image forming units of the upstream image forming section is made to be larger than Qmax on the downstream side.

Furthermore, the structure of the image forming apparatus is not limited to the structure of the above-described exemplary embodiment. The structure of the image forming apparatus may be any one of various structures. For example, an intermediate transfer roller may be used instead of the intermediate transfer belt.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an intermediate transfer body that is configured to rotate;
a downstream image forming section that includes a plurality of image forming units which use toners, which are configured to transfer toner images onto the intermediate transfer body, and which are arranged so that lightness of the toners reduces toward a downstream side along a rotating direction of the intermediate transfer body;
an upstream image forming section that includes at least one image forming unit configured to use a toner having a hue different from hues of the toners used in the plurality of image forming units of the downstream image forming section and having a lightness lower than the lightness of one of the toners having highest lightness among the toners used in the downstream image forming section, which is configured to transfer a toner image onto the intermediate transfer body, and which is disposed upstream of the downstream image forming section in the rotating direction; and
a transfer unit configured to transfer the toner images from the intermediate transfer body to a recording medium,
wherein, in response to a volume mean diameter of the toner of the at least one image forming unit of the upstream image forming section being Dt and a largest volume mean diameter out of volume mean diameters of the toners used in the plurality of image forming units of the downstream image forming section being Dmax, Dt>Dmax holds, and
wherein, when a mass per unit area and a charge amount per unit mass of the toner image transferred onto the intermediate transfer body by the at least one image forming unit of the upstream image forming section are respectively TMAt and TVt and a largest mass per unit area and a largest charge amount per unit mass out of masses per unit area and charge amounts per unit mass of the toner images transferred onto the intermediate transfer body by the plurality of image forming units of the downstream image forming section are respectively TMAmax and TVmax, TMAt×TVt≦TMAmax×TVmax holds.

2. An image forming apparatus comprising:
an intermediate transfer body that is rotated;
a downstream image forming section that includes a plurality of image forming units which use toners, which transfer toner images onto the intermediate transfer body, and which are arranged so that lightness of the toners reduces toward a downstream side along a rotating direction of the intermediate transfer body;
an upstream image forming section that includes at least one image forming unit which uses a toner having a hue different from hues of the toners used in the plurality of image forming units of the downstream image forming section and having lightness lower than the lightness of one of the toners having highest lightness among the toners used in the downstream image forming section, which transfers a toner image onto the intermediate transfer body, and which is disposed upstream of the downstream image forming section in the rotating direction; and
a transfer unit that transfers the toner images from the intermediate transfer body to a recording medium,
wherein, when a charge amount per particle of the toner used in the at least one image forming unit of the upstream image forming section is Qt and a largest charge amount per particle out of charge amounts per particle of the toners used in the plurality of image forming units of the downstream image forming section is Qmax, Qt>Qmax holds.

3. (canceled)

4. The image forming apparatus according to claim 1, wherein the transfer unit includes a transfer belt to which a transfer bias is applied, and wherein a volume resistivity of the transfer belt is set to 10¹² Ωcm or more.
